(19) United States
(12) Patent Application Publication
(10) Pub. No.: US 2024/0184949 A1
(43) Pub. Date: Jun. 6, 2024

(54) IMPLEMENTATION OF A SPLAY STATE BASED ON THE AMPLITUDE ENVELOPES

(71) Applicant: Jiangxi University of Science and Technology, Ganzhou (CN)

(72) Inventors: Weiqing LIU, Ganzhou (CN); Jiangnan XIE, Ganzhou (CN); Jinghong LIN, Ganzhou (CN)

(73) Assignee: Jiangxi University of Science and Technology, Ganzhou (CN)

(21) Appl. No.: 18/210,664

(22) Filed: Jun. 16, 2023

(30) Foreign Application Priority Data
Oct. 24, 2022 (CN) 202211299250.0

(51) Int. Cl. G06F 30/20; H03L 7/00

(52) U.S. Cl. CPC G06F 30/20; H03L 7/00; G06F 2111/10

(57) ABSTRACT

An implementation for a splay state based on amplitude envelopes in the coupled oscillator system includes introducing a heterogeneous oscillator into the globally coupled identical oscillator network, when the frequency mismatch and repulsive coupling strength of the coupled heterogeneous oscillator system satisfy a certain relationship, the time series of the coupled oscillator will modulate an amplitude envelope, which can realize the generation of splay states between the amplitude envelopes of the identical oscillators except for the heterogeneous oscillator; applying the polar coordinate transformation and perturbation analysis in the condition of small coupling strength, it is easy to obtain the evolution equation of the amplitude envelope from the coupled heterogeneous oscillators. Solving the evolution equation of the amplitude envelope, the average amplitude, amplitude, and other parameters of the amplitude envelope in the splay state can be theoretically determined.

### CROSS REFERENCE TO THE RELATED APPLICATION

This application is based upon and claims priority to Chinese Patent Application No. 202211299250.0, filed on Oct. 24, 2022, the entire content of which is incorporated herein by reference.

### TECHNICAL FIELD

The invention belongs to the field of synchronous control technology in nonlinear dynamics, in particular to the modeling, simulation, and theoretical analysis of the coupled oscillator system.

### BACKGROUND

In recent years, the synchronous dynamic behavior of coupled oscillator systems has attracted strong attention in the fields of physics, biology, and engineering. Many functions and self-organizing behaviors of the systems are closely related to various synchronization phenomena. In practical systems such as electronic circuits and biology, the synchronization dynamics of coupled systems have been widely studied. However, before the coupled oscillator system reaches the complete synchronization, the splay state will be originated between the coupled oscillators owing to the coupling induced strong phase correlation, that is, the phases are locked between the coupled oscillator systems with the phase difference between the adjacent two oscillators maintained at 2π/N, where N is the total number of coupled oscillators. The splay state is observed in the globally coupled identical neuron oscillator system, and Zhan Meng et al. observed the generalized splay state in the extremely weakly coupled chaotic identical oscillator system. Zou Wei et al. observed a stable splay state in the coupled identical oscillator chain. The spatially splay state is considered to be an intermediate state generated during synchronous instability and is closely related to many diseases, such as painful epilepsy, tinnitus, and Parkinson's disease. However, in the actual system, there are always parameter differences between some oscillators and the other oscillators. When there is a frequency mismatch caused by parameter differences in the coupled oscillators system, the coupled oscillators exhibit correlations on not only the phases but also the amplitudes. Gonzalez-Miranda et al. observed envelope synchronization in coupled Van der Pol oscillators. Zhan Meng et al. found the phenomenon of the amplitude envelope synchronization under small coupling in two coupled Ginzburg-Landau oscillators. In addition, it is also found that there is synchronization between the envelope of speech and the envelope of the neuron oscillator. Therefore, it is of great significance to study the correlation between envelopes caused by parameter mismatch in coupled oscillator systems for understanding the function realization of biological systems.

### SUMMARY

### 1. Purpose of Invention

In a coupled identical oscillator system, the amplitude envelope is generated by introducing a heterogeneous oscillator. The invention proposes a method and related theory for realizing the splay state of the amplitude envelope in coupled oscillator systems, the generation conditions and main characteristics of the splay state of the amplitude envelope splay state are determined.

### 2. Technical Solutions

A method and related theory for generating splay states of the amplitude envelopes in coupled oscillator systems, including the following steps:

Step 1: constructing N global coupled Ginzburg-Landau oscillator models;

Zᵢ(t)=(a+jωᵢ−|Zᵢ(t)|²)Zᵢ(t)+εΣₖ₌₁^{N}(Zₖ(t)−Zᵢ(t)), i=1,2, . . . , N (1)

in formula (1), state variable Zᵢ(t)=xᵢ(t)+jyᵢ(t), i=1,2, . . . , N, j is a pure imaginary number, ωᵢ represents a natural frequency of the i-th oscillator; in the absence of coupling (ε=0), the amplitude value of each oscillator is \sqrt{a}; when the frequency parameters of all oscillators are set ωᵢ=ω₀, the time series of the coupled oscillators are in splay states under the repulsive coupling (ε<0); when the heterogeneous parameter is introduced into an oscillator in formula (1) of (S1), such as ω₁=ω₀+Δω, the coupled oscillators can be determined to exhibit two different states, phase synchronization state (region I in FIG. 1) and the non-phase-locking state (region II in FIG. 1) in the parameter spaces Δω˜ε by calculating the phase difference between the coupled oscillators.

Step 2: selecting the parameters in the non-phase-locking region (region II in FIG. 1), at this time, heterogeneous oscillator 1 and other identical oscillators in the coupled oscillator system (1) are in a non-phase-locking state; however, the time series of each oscillator is modulated by an amplitude envelope, and the amplitude envelopes of the identical oscillators are in splay states, that is,

$${X}_{i E} ( t ) = {X}_{( i + 1 ) E} ( t + \frac{( i - 1 ) T}{N - 1} ) ,$$

i=2,3, . . . N−1, where X_{iE}(t) is amplitude envelope (X_{iE}) of the i-th oscillator, and T is a period of the amplitude envelope;

assuming Żᵢ(t)=ρᵢ(t)e^{jθ}^{ᵢ}^{(t)} (i=1, 2, 3, . . . , N, N≥3) and converting formula (1) into the polar coordinates,

$${\dot{ρ}}_{i} ( t ) = ( a - ( N - 1 ) ε - {ρ}_{i}^{2} ( t ) ) {ρ}_{i} ( t ) + ε {\sum }_{k = 1 , k \neq i}^{N} {ρ}_{k} ( t ) cos ( {θ}_{k} ( t ) - {θ}_{i} ( t ) ) \qquad ( 2 )$$

$${\dot{θ}}_{i} ( t ) = {ω}_{i} + ε {\sum }_{k = 1 , k \neq i}^{N} \frac{{ρ}_{k} ( t )}{{ρ}_{i} ( t )} sin ( {θ}_{k} ( t ) - {θ}_{i} ( t ) )$$

when the coupling strength ε=0, the amplitude of the time series of a single oscillator is \sqrt{a}, the small amplitude envelope modulated in the time series can be regarded as a small perturbation \tilde{r}ᵢ(t), i=1, 2, . . . , N added to the time series at a small coupling strength; then the amplitude in the coupled oscillators can be expressed as ρᵢ(t)=\sqrt{a}+\tilde{r}ᵢ(5), i=1, 2, . . . , N, and substituting it to formula (2) to obtain the evolution equation of the perturbation \tilde{r}ᵢ(5):

$$\text{?} ( t ) = - ( N - 1 ) ε \sqrt{a} - ( 2 a + ( N - 1 ) ε ) \text{?} ( t ) - 3 \sqrt{a} \text{?} ( t ) + ε \sqrt{a} {\sum }_{k = 1 , k \neq i}^{N} cos ( {θ}_{k} ( t ) - {θ}_{i} ( t ) ) \qquad ( 3 )$$

$${\dot{θ}}_{1} ( t ) = {ω}_{0} + Δω + ε {\sum }_{k = 2 , j + i}^{N} \frac{{ρ}_{k} ( t )}{ρ \text{?} ( t )} sin ( {θ}_{k} ( t ) - {θ}_{1} ( t ) )$$

$${\dot{θ}}_{i} ( t ) = {ω}_{i} + ε {\sum }_{k = 1 , k \neq i}^{N} \frac{{ρ}_{k \text{?}} ( t )}{ρ \text{?} ( t )} sin ( {θ}_{k} ( t ) - {θ}_{i} ( t ) ) , i = 2 , … , N$$

$$\text{?} \text{indicates text missing or illegible when filed}$$

Step 3: solving the phase difference of the coupled identical oscillators Δ [symbol] , i=2,3, . . ., N−1;

under a small coupling strength c, the amplitude of the identical oscillator can be approximately replaced by the average amplitude, that is ρᵢ=ρ̅, i=1,2, . . . , N, in order to facilitate the expression, the heterogeneous oscillator is numbered as 1, and the remaining oscillators are numbered in order of phase from small to large; the phase difference between each adjacent oscillator pair among the identical oscillators is defined as Δ [symbol] (t), i=2, 3, . . . , N−1 and the phase difference between each identical oscillator and heterogeneous oscillator 1 is defined as Δθ_{i,1}, i=2, 3, . . . , N; the numerical results indicates that the phase differences of each pair of oscillators satisfy:

$${Δθ}_{i + 1 , i} ( i ) = {θ}_{i + 1} ( i ) - {θ}_{i} ( i ) = \frac{2 π}{( N - 1 )} + δ ( i ) , i = 2 , 3 , … , N - 1 \qquad ( 4 )$$

where θᵢ(t) is the phase of the i-th oscillator, δ(t) is a tiny oscillating variable with δ(t)→0, replacing the amplitude with the average amplitude ρ̅ in equation (4), the phase difference between identical oscillators i (i=2, 3, . . . , N) and heterogeneous oscillator 1 in equation (3) is determined as

Δ\dot{ }θ_{i,1}(t)=θ̅₁(t)−\dot{θ}ᵢ(t)=Δω−2ε sin(θ₁(t)−θᵢ(t)), i=2, 3, . . . , N (5)

where equation (5) is an Adler equation whose solution is:

$$Δ {θ}_{i , 1} = 2 π [ \frac{y}{T} ] + r τ + 2 arctan ( \frac{Q tan ( 0.5 Qt - π / 2 ) - 2 ε}{Δ w} ) \qquad ( 6 )$$

where Q=\sqrt{Δω²−(2!)²}, is an angle frequency of the amplitude envelope, [ ] represents the value is an operation of upward rounding, T is the period of the envelope, there is

T=2π/\sqrt{Δω²−(2ε)²}

when Δw>>2ε,

Δθ_{i,1}(t)≈Δωt,i=2, 3, . . . , N, (7)

from equation (5), the phase differences between two adjacent oscillators among the identical oscillators satisfy:

\dot{θ}ᵢ₊₁(t)−\dot{θ}ᵢ(t)=ε(sin(θ₁(t)−θᵢ₊₁(t))−sin(θ₁(t)−θᵢ(t))),i=2,3, . . . ,N−1 (8)

substituting equation (4) into formula (8) to obtain:

$$\dot{δ} ( t ) = ε sin ( \frac{π}{N - 1} + \frac{δ ( t )}{2} ) sin ( Δ ω t + \frac{δ ( t )}{2} ) \qquad ( 9 )$$

By omitting a tiny variable δ(t)/2 and solving equation (9), it is easy to obtain:

$$δ ( t ) = - \frac{ε}{Δω} sin ( \frac{π}{N - 1} ) cos ( Δω t ) \qquad ( 10 )$$

Step 4: solving envelope evolution equation ρᵢ(t), i=1,2, . . . ,N;

by introducing equation (4) and equation (7) into equation (3) and omitting the tiny variable δ(t), the evolution equation of perturbation is obtained as follows:

\tilde{\dot{r}}ᵢ(t)=−Nε\sqrt{a}−(2a+(N−1)ε)\tilde{r}ᵢ(t)−3\sqrt{α}\tilde{r}ᵢ²(t)+ε\sqrt{a} cos(Δωt) (11)

solving equation (11) to obtain the solution of the perturbation:

$${\tilde{r}}_{i} ( t ) = {s}_{i} - \frac{\sqrt{a} ε}{\sqrt{Δ {ω}^{2} + 4 {a}^{2} - 4 ( 2 N + 1 ) a ε + {( N - 1 )}^{2} {ε}^{2}}} cos ( Δω t + {φ}_{0} ) , i = 2 , 3 , … , N , \qquad ( 12 )$$

where φ₀ is the initial phase determined by the initial value of the perturbation \tilde{r}ᵢ(t), and Sᵢ. is the mean value of the perturbation term of oscillator i,

$${s}_{i} = \frac{- ( 2 a + ( N - 1 ) ε - \sqrt{{42}^{2} - 4 ( N - 1 ) a ε + {( N - 1 )}^{2} {ε}^{2}}}{6 \sqrt{a}} \qquad ( 13 )$$

therefore, the value of the amplitude envelope can be expressed as:

$${ρ}_{i} ( t ) = \sqrt{a} + {s}_{i} - \frac{\sqrt{a} ε}{\sqrt{{Δω}^{2} + 4 {a}^{2} - 4 ( 2 N + 1 ) a ε + {( N - 1 )}^{2} {ε}^{2}}} cos ( Δωt + {φ}_{0} ) , i \geq 2 \qquad ( 14 )$$

it consists of mean value ρᵢ of the amplitude envelope and amplitude ρᵢ of th amplitude envelope, where the mean value of the amplitude envelope is:

$${\overline{ρ}}_{i} = \sqrt{a} + {s}_{i} = \frac{4 a + ( 1 - N ) ε + \sqrt{4 {a}^{2} ( 2 N + 1 ) a ε + {( N - 1 )}^{2} {ε}^{2}}}{6 \sqrt{a}} \qquad ( 15 )$$

the amplitude of the amplitude envelope is

$${\tilde{ρ}}_{i} = - \frac{\sqrt{a} ε}{\sqrt{{Δω}^{2} + 4 {a}^{2} - 4 ( 2 N + 1 ) a ε + {( N - 1 )}^{2} {ε}^{2}}} \qquad ( 16 )$$

the period of amplitude envelope is:

$$T = \frac{2 π}{Δω} \qquad ( 17 )$$

the above is a theoretical analysis of the main amplitude parameters, mean value, and period of the envelope.

### 3. Beneficial Effects

The invention converts the globally coupled periodic oscillator system into a polar coordinate form and then obtains the evolution equation of the splay state of the amplitude envelope and the evolution equation of the phase difference. In the case of small coupling, solving the differential equation approximately to obtain the theoretical expression of the envelope, and then obtains the main parameters of the envelope in the splay state in different parameter spaces, such as amplitude, period, average amplitude, and so on.

### BRIEF DESCRIPTION OF THE DRAWINGS

FIG. 1 is the Δω˜ε parameter space diagram of the globally coupled Ginzburg-Landau oscillator when N=3, where it has two different types of dynamic behaviors: region I (phase-locking region) and region II (non-phase-locking region).

FIGS. 2A-2B: When N=3, Δω=5, ε=−2, a=15, FIG. 2A is the diagram of time series x_{2,3}(t) of the coupled oscillator 2 and oscillator 3 and their corresponding amplitude envelope x_{iE}(t), i=2,3. FIG. 2B is the time series evolution of the phase difference between coupled oscillator 2 and oscillator 3 Δθ_{3,2}(t) and the time series of the phase difference Δθ_{1,2} between coupled oscillator 1 and oscillator 2 Δθ_{1,2}(t).

FIG. 3 is the definition diagram of the main parameters of the amplitude envelope such as amplitude, mean value, and period.

FIGS. 4A-4D are the relationship diagrams of the main parameters of the amplitude envelope in the splay state, such as amplitude, mean value, and period, change with the coupling strength or the frequency mismatch for N=3, a=15 (the solid lines are the theoretical results, and the point lines are the numerical calculation results). FIG. 4A is the diagram of mean value ρ̅ of the amplitude envelope changes with coupling strength ε for Δω=15,25,35, respectively. FIG. 4B is the relationship diagram of the amplitude \tilde{ρ} of the amplitude envelope with the frequency difference Δω for ε=−0.1, −0.5, −0.7, respectively. FIG. 4C is the diagram of amplitude \tilde{ρ} of the amplitude envelope changes with coupling strength ε for Δω=15,2535 , respectively. FIG. 4D is the diagram of the envelope period changes with frequency difference Δω for ε=−0.1, −0.5, −0.7, respectively.

FIGS. 5A-5B: For N=4, Δω=5, ε=2, α=15, FIG. 5A is the diagram of the time series x_{2, 3, 4}(t) of the coupled oscillator 2, oscillator 3 and oscillator 4, and their corresponding amplitude envelopes x_{iE}(t), i=2, 3, 4. FIG. 5B is the time series of the phase difference between coupled oscillator 2 and oscillator 3 Δθ_{3,2}(t), the phase difference between coupled oscillator 2 and coupled oscillator 4 Δθ_{4,2}(t), and the phase difference between coupled oscillator 1 and oscillator 2 Δθ_{1,2}(t).

FIGS. 6A-6B are the relationship diagrams of the main parameters of the amplitude envelope in the splay state, such as amplitude, mean value, and period, change with the coupling strength or frequency mismatch for N=4, a=15 (the solid lines are the theoretical results, and the point lines are the numerical calculation results). FIG. 6A is the diagram of mean value ρ̅ of the amplitude envelope changes with the coupling strength ε for Δω=15,25,35 , respectively. FIG. 6B is the diagram of amplitude ρ̨ of the amplitude envelope with frequency difference Δω for ε=−0.1, −0.5, −0.7, respectively. FIG. 6C is the diagram of amplitude \tilde{ρ} of the amplitude envelope changes with coupling strength ε for Δω=15, 25, 35, respectively. FIG. 6D is the diagram of the envelope period changes with frequency difference Δω for ε=−0.1, −0.5, −0.7, respectively.

### DETAILED DESCRIPTION OF THE EMBODIMENTS

The following is a further explanation of the invention in combination with embodiments and drawings.

Embodiment 1: When N=3, the splay state of the amplitude envelope of the coupled Ginzburg-Landau oscillator with a heterogeneous oscillator is realized.

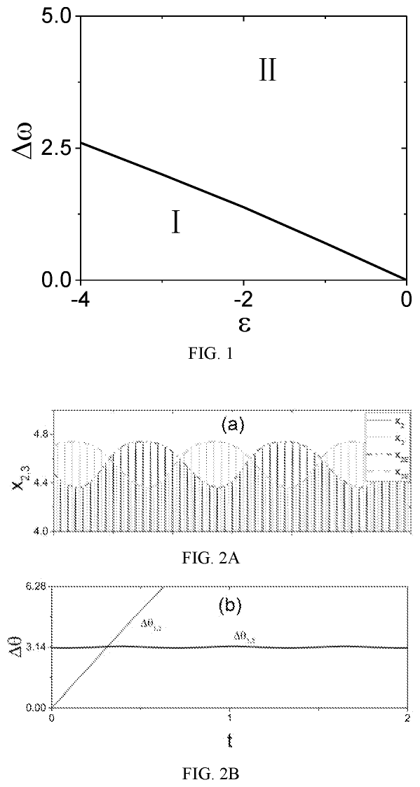

For the globally coupled non-identical Landau oscillator system given by formula (1), when the parameters N=3, ω₀=100, α=15, the frequency difference Δω and the coupling strength ε are taken in the non-phase-locking region (region II) shown in FIG. 1. For example, Δω=, ε=−2, time series x_{2,3}(t) and their corresponding amplitude envelope x_{2,3E}(t) of the identical oscillators (oscillator 2 and oscillator 3) are shown in FIG. 2A, and the amplitude envelopes are in the splay states. The time series of phase difference Δθ_{3,2} between oscillator 2 and oscillator 3 Δθ_{3,2}(t) and the phase difference between oscillator 1 and oscillator 2 Δθ_{1,2}(t) are shown in FIG .2B, where the phase difference between oscillator 2 and oscillator 3 oscillates slightly around π.

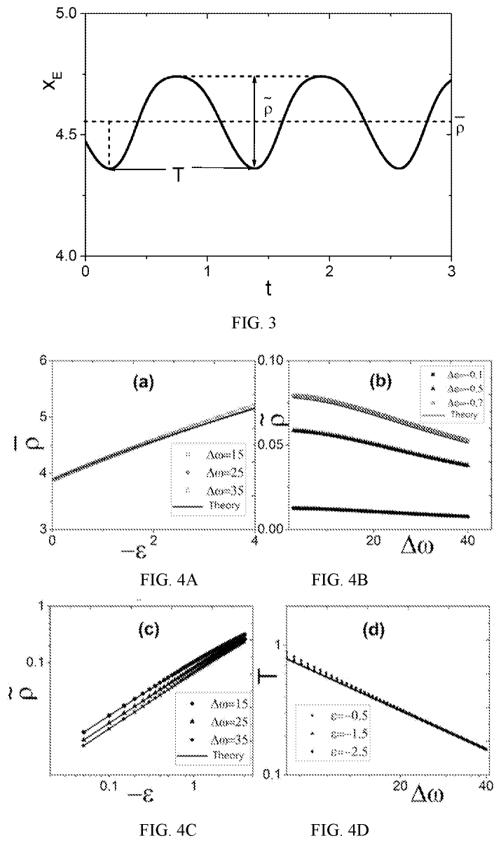

The main characteristics of the amplitude envelope (such as the mean value p̅ᵢ and the amplitude \tilde{p}ᵢ as shown in FIG. 3) versus parameters Δω and ε can be obtained by substituting N=3 into formula (15) and formula (16). The mean values of the amplitude envelopes of identical oscillator 2 and oscillator 3 are:

$${\overline{ρ}}_{2 , 3} = \frac{4 a - 2 ε + 2 \sqrt{{a}^{2} - 7 a ε + {ε}^{2}}}{6 \sqrt{a}} \qquad ( 18 )$$

The amplitudes of the amplitude envelopes of identical oscillator 2 and oscillator 3 are:

$${\tilde{ρ}}_{2 , 3} = \frac{\sqrt{a} ε}{\sqrt{{Δω}^{2} + 4 ( {a}^{2} - 7 a ε + {ε}^{2} )}} \qquad ( 19 )$$

The periods of the amplitude envelopes of identical oscillator 2 and oscillator 3 are:

$$T = \frac{2 π}{Δω} \qquad ( 20 )$$

In FIG. 4A, the relationship diagram of the mean value of the amplitude envelope changes with coupling strength −ε determined by the numerical results and formula (18) are given respectively. At a small coupling strength, the numerical results are in good agreement with the results of formula (18). As the absolute value of the coupling strength ε increases, the average amplitude gradually increases, and it is basically not affected by frequency mismatch Δω. FIG. 4B shows the numerical and theoretical results of the relationship between amplitude \tilde{ρ} of the amplitude envelope and frequency mismatch Δω between the heterogeneous oscillator and the identical oscillators under different coupling strengths ε=−0.1, −0.5, −0.7, respectively. As the increase of Δω, the amplitude of the amplitude envelope gradually decreases. The period of the amplitude envelope in the splay state is inversely proportional to the frequency mismatch.

Embodiment 2: When N=4, the splay state of the amplitude envelope of the coupled Ginzburg-Landau oscillator with a heterogeneous oscillator is realized.

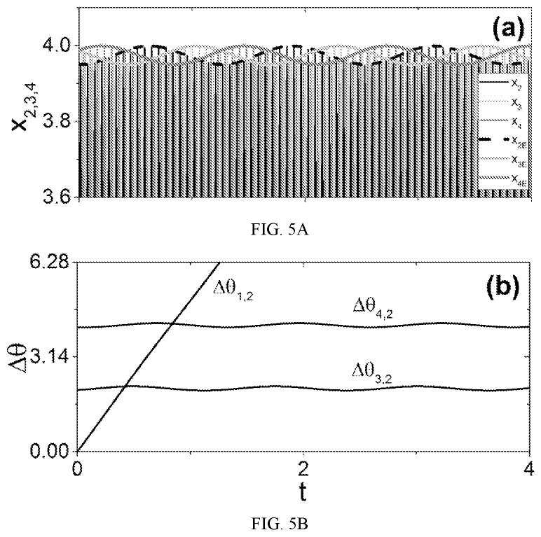

The time series and the corresponding amplitude envelope of the identical oscillators (oscillator 2, oscillator 3 and oscillator 4) in the globally coupled heterogeneous Ginzburg-Landau oscillator system given by formula (1), for the parameters N=4, ω₀=100, a=15, Δω=5, ε=−2, are shown in FIG. 5A, obviously, the amplitude envelope is in a splay state. The phase difference Δθ_{3,2} between oscillator 2 and oscillator 3 Δθ_{3,2}(t) and the phase difference between oscillator 2 and oscillator 4 Δθ_{4,2}(t) oscillate slightly around 2π/3, 4π/3, respectively, while the phase difference between oscillator 2 and oscillator 1 Δθ_{1,2}(t) increases linearly with time, as shown in FIG. 5B.

The main characteristics of the amplitude envelope (the mean value ρ̅ᵢ and the amplitude \tilde{ρ}ᵢ) versus parameters Δω and ε can be obtained by substituting N=4 into formula (15) and formula (16) as shown in FIG. 3. The mean values of the amplitude envelopes of oscillator 2, oscillator 3, and oscillator 4 are:

$${\overline{ρ}}_{2 , 3 , 4} = \frac{4 a - 3 ε + \sqrt{4 {a}^{2} - 36 a ε + 9 {ε}^{2}}}{6 \sqrt{a}} \qquad ( 21 )$$

The amplitudes of the amplitude envelopes of identical oscillator 2, oscillator 3, and oscillator 4 are:

$${\tilde{ρ}}_{2 , 3 , 4} = \frac{\sqrt{a} ε}{\sqrt{{Δω}^{2} + 4 {a}^{2} - 36 a ε + 9 {ε}^{2}}} \qquad ( 22 )$$

The periods of the amplitude envelopes of identical oscillator 2, oscillator 3, and oscillator 4 are:

$$T = \frac{2 π}{Δω} \qquad ( 23 )$$

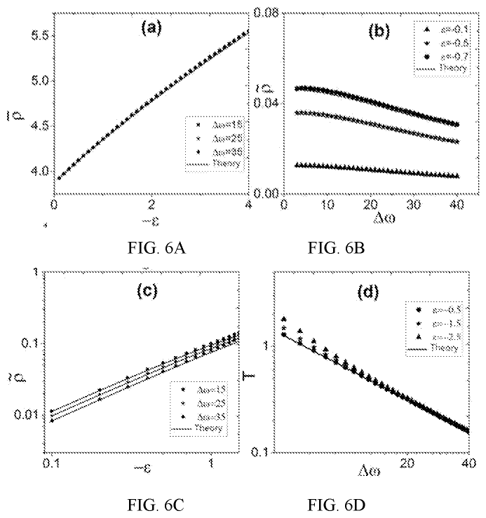

In FIG. 6A, the mean value of the amplitude envelope versus coupling strength −ε determined by the numerical results and formula (21) are given respectively. At a small coupling strength, the numerical results are in good agreement with the results of formula (21). As the absolute value of the coupling strength ε increases, the average amplitude gradually increases, and it is independent with frequency mismatch Δω. FIG. 6B shows the numerical and theoretical results (formula (22)) of the relationship between amplitude \tilde{ρ} of the amplitude envelope and frequency mismatch Δω between the heterogeneous oscillator and the identical oscillator under different coupling strengths ε=−0.1, −0.5, − 0.7, respectively. As the increase of Δω, the amplitude of the amplitude envelope gradually decreases. the amplitude of the amplitude envelope increases with the absolute value of the coupling strength, the period of the amplitude envelope in the splay state is inversely proportional to the frequency mismatch.

What is claimed is:

1. An implementation of a splay state based on amplitude envelopes, comprising: determining a non-phase-locking parameter region by numerically calculating a phase difference between an introduced heterogeneous oscillator and identical oscillators in coupled oscillators; selecting a frequency mismatch and a repulsive coupling strength in the non-phase-locking parameter region for a coupled heterogeneous oscillator system, a splay state is generated among the amplitude envelopes between the identical oscillators except the introduced heterogeneous oscillator.

2. The implementation of the splay state based on the amplitude envelopes according to claim 1, wherein the implementation is realized by the following steps:
(S1): constructing N global coupled Ginzburg-Landau oscillator models;
Zᵢ(t)=(a+jωᵢ−|Zⱼ(t)|²)Zᵢ(t)+εΣₖ₌₁^{N}(Zₖ(t)−Zᵢ(t), i=1,2, . . .,N formula (1)
in the formula (1), state variable Zᵢ(t)=xᵢ(t)+jyᵢ(t), i=1, 2, . . . , N, j is a pure imaginary number, ωᵢ represents a natural frequency of i-th oscillator; in an absence of coupling (ε=0), an amplitude value of each oscillator is \sqrt{a}; when frequency parameters of all oscillators are set ωᵢ=ω₀, time series of the coupled oscillators are in the splay state under a repulsive coupling (ε<0);
(S2): when a heterogeneous parameter is introduced into an oscillator in the formula (1) of (S1), such as ω₁=ω₀+Δω, a parameter mismatch Δω=ω₂−ω₁ is provided between the coupled oscillators, and c is a coupling strength; using a fourth-order Runge-Kutta method to solve the formula (1) for different parameters Δω˜ε, and calculating the phase difference Δθ(t)=θ₂(t)−θ₁(t) between a first oscillator and a second oscillator; when
$${lim}_{t \to ∞} Δ θ ( t ) < 2 π ,$$
the coupled heterogeneous oscillator system is in a phase synchronization region, otherwise, when
$${lim}_{t \to ∞} Δ θ ( t ) > 2 π ,$$
the coupled heterogeneous oscillator system is in the non-phase-locking parameter region, thus the different parameters Δω˜ε of the coupled heterogeneous oscillator system is consisted of the phase synchronization region and the non-phase-locking parameter region;
(S3): selecting parameters in the non-phase-locking parameter region obtained in (S2), a first heterogeneous oscillator and a rest identical oscillators in a first coupled heterogeneous oscillator system are in a non-phase-locking state; however, the time series of each oscillator is modulated by each of the amplitude envelopes, meanwhile the amplitude envelopes of the rest identical oscillators are in a splay state, that is,
$${X}_{iE} ( t ) = {X}_{( i + 1 ) E} ( t + \frac{( i - 1 ) T}{N - 1} ) , i = 2 , 3 , … N - 1 ,$$
where X_{iE}(t) is an amplitude envelope of the i-th oscillator, and T is a period of the amplitude envelope of the i-th oscillator;
applying a polar coordinate transformation and a perturbation analysis in a condition of a small coupling strength to obtain an evolution equation of the amplitude envelopes from the coupled oscillators is obtained theoretically; solving the evolution equation of the amplitude envelopes, an average amplitude, an amplitude, and a period of the amplitude envelopes in the splay state; detailed methods of solving the average amplitude, the amplitude, and the period of the amplitude envelopes in the splay state includes the following steps:
(S4): assuming Żᵢ(t)=ρᵢ(t)e^{jθ}^{ᵢ}^{(t)} (i=1,2,3, . . . , N, N≥3) and converting the formula (1) into polar coordinates,
$${\dot{ρ}}_{i} ( t ) = ( a - ( N - 1 ) ε - {ρ}_{i}^{2} ( t ) ) {ρ}_{i} ( t ) + ε {\sum }_{k = 1 , k \neq i}^{N} {ρ}_{k} ( t ) cos ( {θ}_{k} ( t ) - {θ}_{i} ( t ) ) {\dot{θ}}_{i} ( t ) = {ω}_{i} + ε {\sum }_{k = 1 , k \neq i}^{N} \frac{{ρ}_{k} ( t )}{{ρ}_{i} ( t )} sin ( {θ}_{k} ( t ) - {θ}_{i} ( t ) ) \qquad formula ( 2 )$$
when a coupling strength ε=0, an amplitude of the time series of a single oscillator is \sqrt{a}, a small amplitude envelope modulated in the time series is regarded as a small perturbation \tilde{r}ᵢ(t), i=1, 2, . . . , N added to the time series at the small coupling strength;
(S5): an amplitude of the i-th oscillator in a second coupled heterogeneous oscillator system is expressed as ρᵢ(t)=\sqrt{a}+\tilde{r}ᵢ(t) i=1, 2, . . . , N, and substituting the amplitude of the i-th oscillator in the second coupled heterogeneous oscillator system to formula (2) to obtain an evolution equation of perturbation \tilde{r}ᵢ(t):
$${{r}^{∠}}_{i} = - ( N - 1 ) ε \sqrt{a} - ( 2 a + ( N - 1 ) ε ) {\tilde{r}}_{i} ( t ) - 3 \sqrt{a} {\tilde{r}}_{i}^{2} ( t ) + ε \sqrt{a} {\sum }_{k = 1 , k \neq i}^{N} cos ( {θ}_{k} ( t ) - {θ}_{i} ( t ) ) \qquad formula 3$$
$${\dot{θ}}_{1} ( t ) = {ω}_{0} + Δω + ε {\sum }_{k = 2 , k \neq i}^{N} \frac{{ρ}_{k} ( t )}{{ρ}_{1} ( t )} sin ( {θ}_{k} ( t ) - {θ}_{1} ( t ) )$$
$${\dot{θ}}_{1} ( t ) = {ω}_{i} + ε {\sum }_{k = 1 , k \neq i}^{N} \frac{ρ {k}_{k} ( t )}{{ρ}_{i} ( t )} sin ( {θ}_{k} ( t ) - {θ}_{i} ( t ) ) , i = 2 , … , N$$
(S6): solving the phase difference between the coupled oscillators;
under the small coupling strength ε, the amplitude of the same oscillator is approximately replaced by the average amplitude, that is ρᵢ=ρ̅, i=1,2, . . .,N, in order to facilitate an expression, the introduced heterogeneous oscillator is numbered as 1, and the identical coupled oscillators are numbered in order of phase from small to large; among the identical oscillators, a phase difference Δθ_{i+1,i}(t), i=2,3, . . . ,N−1 between each adjacent oscillator pair is expressed as Δθ_{i+1,i}(t) and a phase difference between each identical oscillator and the first heterogeneous oscillator is expressed as Δθ_{i,1}(t), numerical calculation results show the phase difference between each adjacent oscillator pair is expressed as Δθ_{i+1,i}(t) and satisfies formula (4),
$${Δθ}_{i + 1 , i} ( t ) = {θ}_{i + 1} ( t ) - {θ}_{i} ( t ) = \frac{2 π}{( N - 1 )} + δ ( t ) , i = 2 , 3 , … , N - 1 \qquad formula ( 4 )$$
among them, δ(t) is a small oscillation; based on the numerical calculation results of the formula (4) and using the average amplitude instead of the amplitude of the same oscillator, the phase difference Δθ_{i,1}(t) between each of the identical coupled oscillators and the first heterogeneous oscillator obtained from the formula (3) satisfies:
Δ\dot{ }θ_{i,1}(t)=\dot{θ}₁(t)−θᵢ(t)=Δω−2ε sin(θ₁(t)−θᵢ(t)), i=2, 3, . . . , N formula (5)
where the formula (5) is an Adler equation with a solution:
$$Δ {θ}_{i , 1} ( t ) = 2 π [ \frac{t}{T} ] + π + 2 n ( \frac{Q tan ( 0.5 Qt - π / 2 ) - 2 ε )}{Δ w} ) \qquad formula ( 6 )$$
where Q=\sqrt{Δω²−(2ε)²} is an angle frequency of the amplitude envelope, [ ] represents an operation of an upward rounding, T is a period of the amplitude envelope showing as:
T=2π/\sqrt{Δω²−(2ε)²}
when Δw>>2ε,
Δθ_{i,1}(t)≈Δωt,i=2,3, . . . ,N, formula (7)
from the formula (5) and the formula (3), the phase difference between each adjacent oscillator pair satisfies:
\dot{θ}ᵢ₊₁(t)−\dot{θ}ᵢ(t)=ε(sin(θ₁(t)−θᵢ₊₁(t))−sin(θ₁(t)−θᵢ(t))),i=2,3, . . . ,N−1 (8)
substituting the formula (4) into the formula (8), a small oscillation δ(t) of the phase difference between the adjacent oscillator pair satisfies:
$$\dot{δ} ( t ) = ε sin ( \frac{π}{N - 1} + \frac{δ ( t )}{2} ) sin ( Δ ω t + \frac{δ ( t )}{2} ) \qquad formula ( 9 )$$
solving the formula (9) by omitting a tiny variable δ(t)/2 to obtain:
$$δ ( t ) = - \frac{ε}{Δ} sin ( \frac{π}{N - 1} ) cos ( Δ wt ) \qquad formul a ( 10 )$$
(S7): solving an envelope evolution formula ρᵢ(t), i=1, 2, . . . , N;
by introducing the formula (4) and the formula (7) into the formula (3), an evolution formula of a perturbation is obtained as follows:
\tilde{\dot{r}}ᵢ(t)=−Nε\sqrt{a}−(2a+(N−1)ε)\tilde{r}ᵢ(t)−3\sqrt{α}\tilde{r}ᵢ²(t)+ε\sqrt{a} cos(Δωt) (11)
solving the formula (11) to obtain a solution of the perturbation \tilde{r}ᵢ(t):
$${\tilde{r}}_{i} ( t ) = {s}_{i} - \frac{\sqrt{a} ε}{\sqrt{Δ {ω}^{2} + 4 {a}^{2} - 4 ( 2 N + 1 ) a ε + {( N - 1 )}^{2} {ε}^{2}}} cos ( Δ wt + {φ}_{0} ) , i = 2 , 3 , … , N , \qquad formula ( 12 )$$
where φ₀ is an initial phase determined by an initial value of the perturbation \tilde{r}ᵢ(t), and Sᵢ. is a mean value of a perturbation term of the i-th oscillator,
$${s}_{i} = \frac{- ( 2 a + ( N - 1 ) ε - \sqrt{4 {a}^{2} - 4 ( 2 N + 1 ) a ε + {( N - 1 )}^{2} {ε}^{2}}}{6 \sqrt{a}} \qquad formula ( 13 )$$
therefore, a value of the amplitude envelope is expressed as:
$${ρ}_{i} ( t ) = \sqrt{a} + {s}_{i} - \frac{\sqrt{a} ε}{\sqrt{Δ {ω}^{2} + 4 {a}^{2} - 4 ( 2 N + 1 ) a ε + {( N - 1 )}^{2} {ε}^{2}}} cos ( Δω t + {φ}_{0} ) , i \geq 2 \qquad fomrula ( 14 )$$
the value of the amplitude envelope consists of a mean value ρ̅ᵢ of the amplitude envelope and an amplitude \tilde{ρ}ᵢ of the amplitude envelope, wherein the mean value of the amplitude envelope is:
$${\overline{ρ}}_{i} = \sqrt{a} + {s}_{i} = \frac{4 a + ( 1 - N ) ε + \sqrt{4 {a}^{2} - 4 ( N - 1 ) a ε + {( N - 1 )}^{2} {ε}^{2}}}{6 \sqrt{a}} \qquad formula ( 15 )$$
an amplitude of the amplitude envelope is:
$${\tilde{ρ}}_{i} = - \frac{\sqrt{a} ε}{\sqrt{Δ {ω}^{2} + 4 {a}^{2} - 4 ( 2 N + 1 ) a ε + {( N - 1 )}^{2} {ε}^{2}}} \qquad formula ( 16 )$$
the period of the amplitude envelope is:
$$T = \frac{\underline{2} π}{Δ ω} \qquad formula ( 17 )$$
the above is a theoretical analysis of main amplitude parameters, the mean value, and the period of the amplitude envelope.
